(19) United States
(12) Patent Application Publication
(10) Pub. No.: US 2026/0079091 A1
(43) Pub. Date: Mar. 19, 2026

(54) APPARATUS AND METHOD FOR MANUFACTURING ELECTRODE OF SECONDARY BATTERY

(71) Applicant: SAMSUNG SDI CO., LTD., Yongin-si, (KR)

(72) Inventor: Minjun KIM, Yongin-si (KR)

(21) Appl. No.: 19/214,486

(22) Filed: May 21, 2025

(30) Foreign Application Priority Data
Sep. 13, 2024 (KR) 10-2024-0125987

(51) Int. Cl. G01N 11/00; H01M 4/04

(52) U.S. Cl. CPC G01N 11/00; H01M 4/0404

(57) ABSTRACT

An apparatus for manufacturing an electrode of a secondary battery, the apparatus including a stirring device to generate a first positive electrode slurry, the stirring device configured to sir a mixed solution containing a positive electrode active material, a conductive agent, a binder, and an N-methyl-n-pyrrolidone (NMP) solvent, a de-ironizing device to generate a second positive electrode slurry, the de-ironizing device configured to perform a de-ironizing process on the first positive electrode slurry from the stirring device, a degassing device for generating a third positive electrode slurry, the degassing device configured to perform a degassing process on the second positive electrode slurry from the de-ironizing device and to stir the second positive electrode slurry, and a coating device to apply the third positive electrode slurry from the degassing device onto a positive electrode plate.

This application claims priority under 35 U.S.C. §119 to Korean Patent Application No. 10-2024-0125987, filed in the Korean Intellectual Property Office on September 13, 2024, the entire contents of which are hereby incorporated by reference.

### BACKGROUND

### 1. Field

The embodiments of the present disclosure relate to an apparatus and method for manufacturing an electrode of a secondary battery.

### 2. Description Of The Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments are directed to an apparatus for manufacturing an electrode of a secondary battery, the apparatus including a stirring device to generate a first positive electrode slurry, the stirring device configured to sir a mixed solution containing a positive electrode active material, a conductive agent, a binder, and an N-methyl-n-pyrrolidone (NMP) solvent, a de-ironizing device to generate a second positive electrode slurry, the de-ironizing device configured to perform a de-ironizing process on the first positive electrode slurry from the stirring device, a degassing device for generating a third positive electrode slurry, the degassing device configured to perform a degassing process on the second positive electrode slurry from the de-ironizing device and to stir the second positive electrode slurry, and a coating device to apply the third positive electrode slurry from the degassing device onto a positive electrode plate.

The degassing device may include a measuring device configured to measure a viscosity of the third positive electrode slurry.

The de-ironizing device may include a first storage tank configured to store the first positive electrode slurry transferred from the stirring device, and a de-ironizer configured to remove an iron component from the first positive electrode slurry.

The de-ironizer may be configured to perform the de-ironizing process for 80 minutes to 100 minutes.

The degassing device may include a second storage tank configured to store the second positive electrode slurry transferred from the de-ironizing device, a vacuum degasser configured to remove air bubbles from the second positive electrode slurry in a vacuum, and a stirrer configured to stir the second positive electrode slurry from which the air bubbles have been removed.

The vacuum degasser may be configured to perform the degassing process for 80 minutes to 100 minutes.

The stirrer may be configured to stir the second positive electrode slurry from which the air bubbles have been removed for 25 days to 30 days.

The stirrer may include a rotary blade configured to rotate at a stirring rotation speed of 15 rpm to 25 rpm.

The stirrer may be configured to stir the second positive electrode slurry from which the air bubbles have been removed at a temperature of 20°C to 30°C.

The degassing device is configured to generate a third positive electrode slurry having a solid concentration of 70 wt% to 80 wt%, and a viscosity of 500 cPs to 1,700 cPs.

Embodiments are directed to an apparatus including a stirring device configured to generate a first positive electrode slurry by stirring a mixed solution containing a positive electrode active material, a conductive agent, a binder, and an N-methyl-n-pyrrolidone (NMP) solvent, a de-ironizing device configured to generate a second positive electrode slurry by performing a de-ironizing process on the first positive electrode slurry transferred from the stirring device, a degassing device configured to generate a third positive electrode slurry by performing a degassing process on the second positive electrode slurry transferred from the de-ironizing device and to generate a fourth positive electrode slurry by stirring the third positive electrode slurry, and a coating device configured to apply the fourth positive electrode slurry transferred from the degassing device onto a positive electrode plate.

The de-ironizing device may include a first storage tank configured to store the first positive electrode slurry transferred from the stirring device, the degassing device may include, a second storage tank configured to store the second positive electrode slurry transferred from the de-ironizing device, a vacuum degasser configured to remove air bubbles from the second positive electrode slurry in a vacuum, a third storage tank configured to store the third positive electrode slurry transferred from the second storage tank, and a stirrer configured to stir the third positive electrode slurry.

The degassing device may further include a measuring device configured to measure a viscosity of the third positive electrode slurry and the fourth positive electrode slurry.

The degassing device may be configured to generate a third positive electrode slurry having a solid concentration of 70 wt% to 80 wt%, and a viscosity of 2,500 cPs to 3,500 cPs.

The degassing device is configured to generate a fourth positive electrode slurry having a solid concentration of 70 wt% to 80 wt%, and a viscosity of 1,500 cPs to 1,700 cPs.

Embodiments are directed to a method for manufacturing an electrode of a secondary battery, the method including generating a first positive electrode slurry by stirring a mixed solution containing a positive electrode active material, a conductive agent, a binder, and an N-methyl-n-pyrrolidone (NMP) solvent, generating a second positive electrode slurry by performing a de-ironizing process on the first positive electrode slurry, generating a third positive electrode slurry by performing a degassing process on the second positive electrode slurry, generating a fourth positive electrode slurry by stirring the third positive electrode slurry for a certain period of time, and applying the fourth positive electrode slurry onto a positive electrode plate.

The method may further include measuring a viscosity of the third positive electrode slurry and the fourth positive electrode slurry.

Generating the second positive electrode slurry may include performing the de-ironizing process for 80 minutes to 100 minutes.

Generating the third positive electrode slurry may include performing the degassing process for 80 minutes to 100 minutes.

Generating the fourth positive electrode slurry may include stirring the third positive electrode slurry at a temperature of 20°C to 30°C for 25 days to 30 days.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a diagram for describing an apparatus for manufacturing an electrode of a secondary battery according to some embodiments of the present disclosure;

FIG. 2 illustrates a schematic diagram for describing an apparatus for manufacturing an electrode of a secondary battery according to a first embodiment;

FIG. 3 illustrates a degassing device according to the first embodiment;

FIG. 4 illustrates a schematic diagram for describing an apparatus for manufacturing an electrode of a secondary battery according to a second embodiment;

FIG. 5 illustrates a diagram showing a degassing device according to the second embodiment; and

FIGS. 6 to 9 illustrate flowcharts showing a method for manufacturing an electrode of a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terms used in the present specification are for describing embodiments of the present disclosure and are not intended to limit the present disclosure.

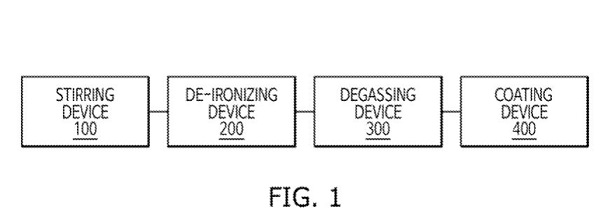

FIG. 1 illustrates a diagram for describing an apparatus 10 for manufacturing an electrode of a secondary battery according to some embodiments of the present disclosure.

Referring to FIG. 1, the apparatus 10 for manufacturing an electrode of a secondary battery according to some embodiments may include, e.g., a stirring device 100, a de-ironizing device 200, a degassing device 300, and a coating device 400.

The apparatus 10 for manufacturing an electrode of a secondary battery in FIG. 1 is an apparatus for manufacturing a positive electrode slurry of an electrode of a secondary battery. Specifically, the apparatus 10 for manufacturing an electrode of a secondary battery according to some embodiments of the present disclosure may generate a positive electrode slurry having an optimal viscosity. The optimal viscosity may mean a viscosity at which a positive electrode slurry may be uniformly applied onto a positive electrode plate. In an implementation, during a coating process, a positive electrode slurry having a high viscosity of, e.g., 2,000 cPs (centipoise) to 3,500 cPs may be non-uniformly applied onto a positive electrode plate. The positive electrode slurry that is non-uniformly applied may cause rupture of the positive electrode plate. To solve this problem, the apparatus 10 for manufacturing an electrode of a secondary battery according to some embodiments of the present disclosure may reduce the viscosity of the positive electrode slurry. In an implementation, the apparatus 10 for manufacturing an electrode of a secondary battery may control the positive electrode slurry to have an optimal viscosity of, e.g., 1,500 cPs to 1,700 cPs.

The stirring device 100 may generate the positive electrode slurry by stirring a mixed solution. The mixed solution may include, e.g., a positive electrode active material, a conductive agent, a binder, and an N-methyl-n-pyrrolidone (NMP) solvent. In some embodiments, the mixed solution may further include an additive. In an implementation, the additive may include, e.g., an oxalic acid. The positive electrode slurry may be a slurry applied onto the positive electrode plate of the secondary battery.

The positive electrode slurry may be transferred in the order of the stirring device 100, the de-ironizing device 200, the degassing device 300, and the coating device 400. For example, the positive electrode slurry may be transferred from the stirring device 100, to the de-ironizing device 200, to the degassing device 300, and finally to the coating device 400. The stirring device 100, the de-ironizing device 200, the degassing device 300, and the coating device 400 may be directly connected to each other, or they may be connected to each other, e.g., by connecting pipes, or they may be connected to each other, e.g., via connecting pipes and additional components (e.g., flow rate control valved, pumps, or the like).

The de-ironizing device 200 may be a device that performs a de-ironizing process. The de-ironizing process may be a process of removing an iron (Fe) material, magnetic foreign materials, or the like which may be contained in the positive electrode slurry. A positive electrode slurry containing the iron material may reduce the stability of the secondary battery. Accordingly, the de-ironizing process may be performed in order to help improve the safety of the electrode of the secondary battery or the secondary battery including the same as well as the efficiency of the manufacturing process.

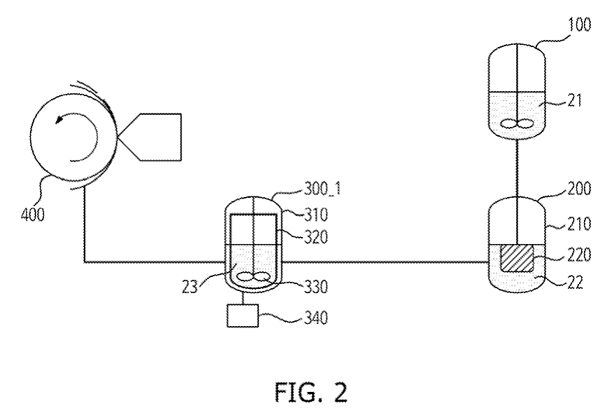

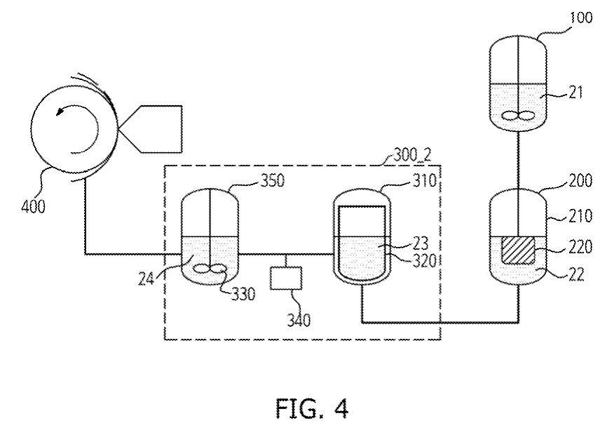

The de-ironizing device 200 may perform the de-ironizing process on the positive electrode slurry transferred from the stirring device 100. The configuration of the de-ironizing device 200 is described in detail with reference to FIGS. 2 and 4.

The degassing device 300 may be a device that performs a degassing process. The degassing process may be a process of removing air bubbles contained in the positive electrode slurry. In an implementation, during the process of manufacturing the mixed solution, the positive electrode slurry may contain air bubbles. The positive electrode slurry containing air bubbles may cause electrode defects during the coating process and the drying process. Accordingly, the degassing process may be performed in order to improve the manufacturing efficiency and the safety of the electrode of the secondary battery or the secondary battery including the same.

The degassing device 300 may perform the degassing process on the positive electrode slurry transferred from the de-ironizing device 200. The configuration of the degassing device 300 is described in detail with reference to FIGS. 2 to 5.

The coating device 400 may apply the positive electrode slurry transferred from the degassing device 300 onto the positive electrode plate. The coating device 400 may receive the positive electrode slurry having an optimal viscosity from the degassing device 300. In an implementation, the coating device 400 may uniformly apply the positive electrode slurry having an optimal viscosity onto the positive electrode plate.

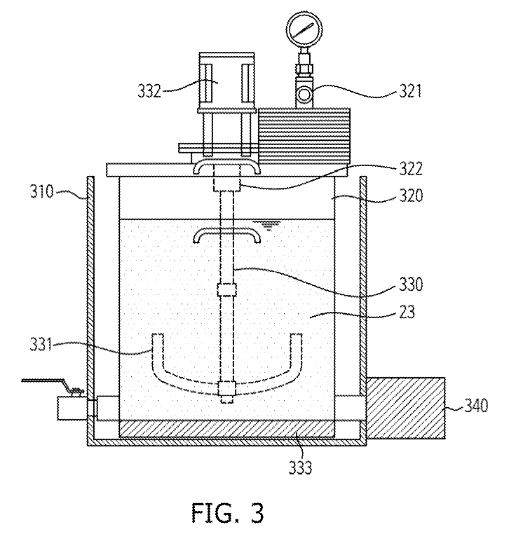

FIG. 2 illustrates a schematic diagram for describing an apparatus 10_1 for manufacturing an electrode of a secondary battery according to a first embodiment, and FIG. 3 illustrates a degassing device 300_1 according to the first embodiment.

Referring to FIG. 2, the apparatus 10_1 for manufacturing an electrode of a secondary battery may include, e.g., a stirring device 100, a de-ironizing device 200, the degassing device 300_1, and a coating device 400.

The apparatus 10_1 for manufacturing an electrode of a secondary battery in FIG. 2 is an example of the apparatus 10 for manufacturing an electrode of a secondary battery in FIG. 1. Hereinafter, for convenience of explanation, the differences from those described with reference to FIG. 1 is mainly described.

The stirring device 100 may include, e.g., a stirrer. The stirring device 100 may generate a first positive electrode slurry 21 by stirring a mixed solution. The mixed solution may include, e.g., a positive electrode active material, a conductive agent, a binder, and an NMP solvent. In some embodiments, the mixed solution may further include an additive. In an implementation, the additive may include, e.g., oxalic acid. The volume of the mixed solution may be, e.g., 1,800 liters (l).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

The positive electrode active material may be used to manufacture a positive electrode for a rechargeable lithium battery.

A positive electrode for a rechargeable lithium battery may include a current collector and a positive electrode active material layer on the current collector. The positive electrode active material layer may include a positive electrode active material and may further include a binder and/or a conductive material(e.g., an electrically conductive material).

For example, the positive electrode may further include an additive that can serve as a sacrificial positive electrode.

For example, the additive may include, e.g., oxalic acid.

An amount of the positive electrode active material may be about 90 wt% to about 99.5 wt% based on 100 wt% of the positive electrode active material layer. Amounts of the binder and the conductive material may be about 0.5 wt% to about 5 wt%, respectively, based on 100 wt% of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity(e.g., electrical conductivity) to the electrode. Any material that does not cause chemical change(e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

The stirring device 100 may transfer the first positive electrode slurry 21 to the de-ironizing device 200. In an implementation, the first positive electrode slurry 21 generated by the stirring device 100 may be transferred to the de-ironizing device 200 via a connecting pipe connecting the stirring device 100 to the de-ironizing device 200 and additional components (e.g., a flow rate control valve, a pump, or the like).

The de-ironizing device 200 may perform the de-ironizing process on the first positive electrode slurry 21.

The de-ironizing device 200 may include a first storage tank 210 and a de-ironizer 220.

The first storage tank 210 may store the first positive electrode slurry 21 transferred from the stirring device 100. In the first storage tank 210, the de-ironizing process may be performed on the first positive electrode slurry 21.

The de- ironizer 220 may remove an iron component from the first positive electrode slurry 21. In an implementation, the de-ironizer 220 may be an electromagnetic de-ironizer or a de-ironing filter. The first positive electrode slurry 21 from which the iron component has been removed may be a second positive electrode slurry 22. That is, because the de-ironizer 220 performs the de-ironizing process on the first positive electrode slurry 21, the de-ironizing device 200 may generate the second positive electrode slurry 22.

In an embodiment, the de-ironizing device 200 may perform the de-ironizing process, e.g., for 80 minutes to 100 minutes. In some embodiments, the de-ironizing device 200 may perform the de-ironizing process, e.g., for 90 minutes.

The de-ironizing device 200 may transfer the second positive electrode slurry 22 to the degassing device 300_1. In an implementation, the second positive electrode slurry 22 generated by the de-ironizing device 200 may be transferred to the degassing device 300_1 via a connecting pipe connecting the de-ironizing device 200 to the degassing device 300_1 and additional components (e.g., a flow rate control valve, a pump, or the like).

The degassing device 300_1 may perform the degassing process on the second positive electrode slurry 22. That is, the degassing device 300_1 may generate a third positive electrode slurry 23 through a degassing process.

Referring to FIG. 3, the degassing device 300_1 may include, e.g., a second storage tank 310, a vacuum degasser 320, a stirrer 330, and a measuring device 340.

The second storage tank 310 may store the second positive electrode slurry 22 transferred from the de-ironizing device 200. In the second storage tank 310, the degassing process may be performed on the second positive electrode slurry 22.

The vacuum degasser 320 may include, e.g., a vacuum pump 321 and a thermometer 322. The vacuum degasser 320 may be inside the second storage tank 310.

The second positive electrode slurry 22 may be left in a container of the vacuum degasser 320 for several minutes. The vacuum degasser 320 may remove air bubbles contained in the second positive electrode slurry 22 by driving the vacuum pump 321.

In an implementation, the degassing device 300_1 may perform the degassing process, e.g., for 80 minutes to 100 minutes. In some embodiments, the degassing device 300_1 may perform the degassing process , e.g., for 90 minutes.

The thermometer 322 may measure the temperature of the second positive electrode slurry 22 from which air bubbles have been removed. The thermometer 322 may transmit the temperature measurement result to a controller and a heater 333 so that the second positive electrode slurry 22 may be maintained at a temperature , e.g., of 20°C to 30°C. In some embodiments, the thermometer 322 may measure the temperature of the second positive electrode slurry 22 from which air bubbles have been removed, and transmit the temperature measurement result to the controller and the heater 333, so that it may be measured whether the second positive electrode slurry 22 is maintained at a temperature of 25° C.

The stirrer 330 may include, e.g., a rotary blade 331, a motor 332, and a heater 333. The stirrer 330 may be joined to the vacuum degasser 320.

The stirrer 330 may stir the second positive electrode slurry 22 from which air bubbles have been removed for a certain period of time. In an implementation, the stirrer 330 may stir the second positive electrode slurry 22 from which air bubbles have been removed, e.g., for 25 days to 30 days. In some embodiments, the stirrer 330 may stir the second positive electrode slurry 22 from which air bubbles have been removed, e.g., for 27 days.

The stirrer 330 may reduce the viscosity of the second positive electrode slurry 22 from which air bubbles have been removed. In an implementation, the viscosity of the second positive electrode slurry 22 from which air bubbles have been removed may be, e.g., 3,000 cPs. In a case where the stirrer 330 stirs the second positive electrode slurry 22 from which air bubbles have been removed for 27 days, the viscosity of the second positive electrode slurry 22 from which air bubbles have been removed may be reduced. The second positive electrode slurry 22 from which air bubbles have been removed and of which the viscosity has been reduced may be a third positive electrode slurry 23. That is, the degassing device 300_1 may generate the third positive electrode slurry 23 by performing a degassing process and a stirring operation on the second positive electrode slurry 22. The viscosity of the third positive electrode slurry 23 may be, e.g., 1,500 cPs to 1,700 cPs. In some embodiments, the viscosity of the third positive electrode slurry 23 may be, e.g., 1,600 cPs.

The rotary blade 331 may have a constant stirring rotation speed by the motor 332, and the rotary blade 331 may stir the second positive electrode slurry 22 from which air bubbles have been removed. In an implementation, the rotary blade 331 may stir the second positive electrode slurry 22 from which air bubbles have been removed at a stirring rotation speed of, e.g., 15 rpm to 25 rpm. In some embodiments, the rotary blade 331 may stir the second positive electrode slurry 22 from which air bubbles have been removed at a stirring rotation speed of 20 rpm.

Depending on the measurement result of the thermometer 322, the heater 333 may raise or lower the internal temperature of the second storage tank 310 or the vacuum degasser 320. In an implementation, the thermometer 322 may measure the temperature of the second positive electrode slurry 22 from which air bubbles have been removed. As the measurement result of the thermometer 322, in a case where the temperature of the second positive electrode slurry 22 is, e.g., lower than 25°C, the heater 333 may operate to raise the temperature. In contrast, in a case where the temperature of the second positive electrode slurry 22 is, e.g., higher than 25°C, the heater 333 may operate to lower the temperature. For example, the heater 333 may be capable of a cooling operation.

The measuring device 340 may measure the viscosity of the third positive electrode slurry 23. The measuring device 340 may be, e.g., installed adjacent to the second storage tank 310 or may be installed inside the second storage tank 310.

The measuring device 340 may determine whether the viscosity of the third positive electrode slurry 23 is, e.g., 1,500 cPs to 1,700 cPs. That is, the optimal viscosity range for the third positive electrode slurry 23 may be, e.g., 1,500 cPs to 1,700 cPs.

The measuring device 340 may measure the solid concentration of the third positive electrode slurry 23. In an implementation, the measuring device 340 may determine whether the solid concentration of the third positive electrode slurry 23 is, e.g., 70 wt% to 80 wt%.

The degassing device 300_1 may transfer the third positive electrode slurry 23 to the coating device 400. In an implementation, the third positive electrode slurry 23 generated by the degassing device 300_1 may be transferred to the coating device 400 via a connecting pipe connecting the degassing device 300_1 to the coating device 400 and additional components (e.g., a flow rate control valve, a pump, or the like).

Referring again to FIG. 2, the coating device 400 may apply the third positive electrode slurry 23 onto the positive electrode plate. In an implementation, the coating device 400 may include, e.g., a die coater. The die coater may be spaced apart from the positive electrode plate, i.e. the substrate. The die coater may include a nozzle formed in a slit shape. The third positive electrode slurry 23 may be discharged through the nozzle of the die coater so that the third positive electrode slurry 23 is applied onto the substrate.

As described above, the apparatus 10_1 for manufacturing an electrode of a secondary battery according to some embodiments may improve the efficiency of the process of manufacturing an electrode of a secondary battery by controlling the positive electrode slurry to have an optimal viscosity before applying the positive electrode slurry onto the positive electrode plate.

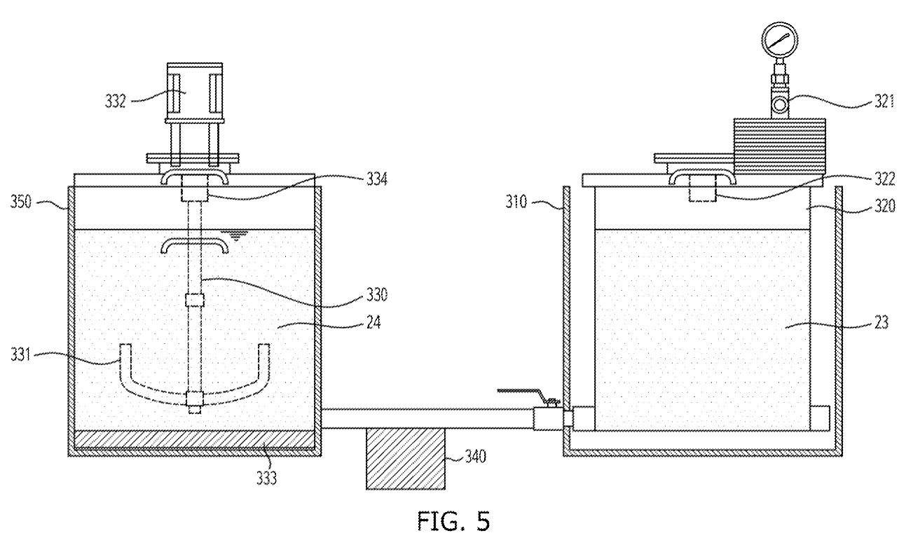

FIG. 4 illustrates a schematic diagram for describing an apparatus 10_2 for manufacturing an electrode of a secondary battery according to a second embodiment, and FIG. 5 illustrates a diagram showing a degassing device 300_2 according to the second embodiment. For convenience of explanation, the differences from those described with reference to FIGS. 2 and 3 are mainly described.

Referring to FIG. 4, the apparatus 10_2 for manufacturing an electrode of a secondary battery may include, e.g., a stirring device 100, a de-ironizing device 200, the degassing device 300_2, and a coating device 400.

The degassing device 300_2 according to some embodiments may include, e.g., a second storage tank 310, a vacuum degasser 320, a stirrer 330, a measuring device 340, and a third storage tank 350.

The degassing device 300_2 of FIG. 4 may perform a degassing process in the second storage tank 310 and perform a stirring operation in the third storage tank 350. In some embodiments, the degassing device 300_1 of FIG. 3 may perform both the degassing process and the stirring operation in the second storage tank 310. That is, the degassing device 300_2 of FIG. 4 may separately perform the degassing process and the stirring operation. Accordingly, the degassing device 300_2 of FIG. 4 may perform the manufacturing process more precisely and accurately than the degassing device 300_1 of FIG. 3.

Referring to FIG. 5, the second storage tank 310 may store the second positive electrode slurry 22 transferred from the de-ironizing device 200. In the second storage tank 310, the degassing process may be performed on the second positive electrode slurry 22. The second positive electrode slurry 22 from which air bubbles have been removed may be a third positive electrode slurry 23.

The vacuum degasser 320 may include, e.g., a vacuum pump 321 and a thermometer 322. The vacuum degasser 320 may be inside the second storage tank 310.

The second positive electrode slurry 22 may be left in a container of the vacuum degasser 320 for several minutes. The vacuum degasser 320 may remove air bubbles contained in the second positive electrode slurry 22 by driving the vacuum pump 321.

In an implementation, the degassing device 300_2 may perform the degassing process, e.g., for 80 minutes to 100 minutes. In some embodiments, the degassing device 300_2 may perform the degassing process, e.g., for 90 minutes.

The thermometer 322 may measure the temperature of the third positive electrode slurry 23. The thermometer 322 may transmit the temperature measurement result to a controller and a heater 333, so that it may be measured whether the third positive electrode slurry 23 is maintained at a temperature, e.g., of 20°C to 30°C. In some embodiments, it may be measured whether the third positive electrode slurry 23 is maintained at a temperature, e.g., of 25°C.

The third storage tank 350 may store the third positive electrode slurry 23 transferred from the second storage tank 310. In the third storage tank 350, the third positive electrode slurry 23 may be stirred.

The stirrer 330 may include, e.g., a rotary blade 331, a motor 332, a heater 333, and a thermometer 334. The stirrer 330 may be inside the third storage tank 350.

The stirrer 330 may stir the third positive electrode slurry 23 from which air bubbles have been removed for a certain period of time. In an implementation, the stirrer 330 may stir the third positive electrode slurry 23, e.g., for 25 days to 30 days. In some embodiments, the stirrer 330 may stir the third positive electrode slurry 23, e.g., for 27 days.

The stirrer 330 may reduce the viscosity of the third positive electrode slurry 23. In an implementation, the viscosity of the third positive electrode slurry 23 may be, e.g., 3,000 cPs. In a case where the stirrer 330 stirs the third positive electrode slurry 23 for 27 days, the viscosity of the third positive electrode slurry 23 may be reduced. The third positive electrode slurry 23 with the reduced viscosity may be a fourth positive electrode slurry 24. The viscosity of the fourth positive electrode slurry 24 may be, e.g., 1,500 cPs to 1,700 cPs. In some embodiments, the viscosity of the fourth positive electrode slurry 24 may be, e.g., 1,600 cPs.

The rotary blade 331 may have a constant stirring rotation speed by the motor 332, and the rotary blade 331 may stir the third positive electrode slurry 23. In an implementation, the rotary blade 331 may stir the third positive electrode slurry 23 at a stirring rotation speed, e.g., of 15 rpm to 25 rpm. In some embodiments, the rotary blade 331 may stir the third positive electrode slurry 23 at a stirring rotation speed, e.g., of 20 rpm.

Depending on the measurement result of the thermometer 334, the heater 333 may raise or lower the internal temperature of the third storage tank 350. In an implementation, the thermometer 334 may measure the temperature of the third positive electrode slurry 23. As the measurement result of the thermometer 334, in a case where the temperature of the third positive electrode slurry 23 is, e.g., lower than 25°C, the heater 333 may operate to raise the temperature. In contrast, in a case where the temperature of the third positive electrode slurry 23 is, e.g., higher than 25°C, the heater 333 may operate to lower the temperature.

The measuring device 340 may measure the viscosity of the third positive electrode slurry 23 and the fourth positive electrode slurry 24. The measuring device 340 may be, e.g., installed adjacent to the second storage tank 310 and the third storage tank 350.

The measuring device 340 may determine whether the viscosity of the third positive electrode slurry 23 is, e.g., 2,500 cPs to 3,500 cPs. In some embodiments, the measuring device 340 may determine whether the viscosity of the third positive electrode slurry 23 is, e.g., 3,000 cPs.

The measuring device 340 may determine whether the viscosity of the fourth positive electrode slurry 24 is, e.g., 1,500 cPs to 1,700 cPs. In an implementation, the optimal viscosity range for the fourth positive electrode slurry 24 may be, e.g., 1,500 cPs to 1,700 cPs. In some embodiments, the measuring device 340 may determine whether the viscosity of the fourth positive electrode slurry 24 is, e.g., 1,600 cPs.

The measuring device 340 may measure the solid concentration of the third positive electrode slurry 23 and the fourth positive electrode slurry 24. In an implementation, the measuring device 340 may determine whether the solid concentration of the third positive electrode slurry 23 and the fourth positive electrode slurry 24 is, e.g., 70 wt% to 80 wt%.

The degassing device 300_2 may transfer the fourth positive electrode slurry 24 to the coating device 400.

Referring again to FIG. 4, the coating device 400 may apply the fourth positive electrode slurry 24 onto the positive electrode plate. The fourth positive electrode slurry 24 may be discharged through the nozzle of the die coater provided in the coating device 400 so that the fourth positive electrode slurry 24 may be applied onto the substrate.

As described above, the apparatus 10_2 for manufacturing an electrode of a secondary battery according to some embodiments may improve the efficiency of the process of manufacturing an electrode of a secondary battery by controlling the positive electrode slurry to have an optimal viscosity before applying the positive electrode slurry onto the positive electrode plate.

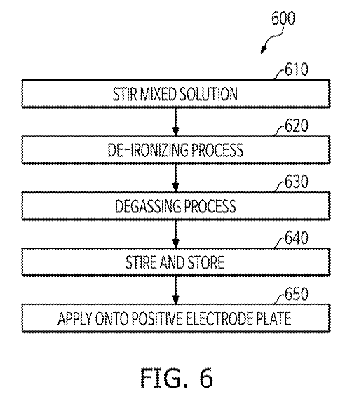

FIGS. 6 to 9 illustrate flowcharts showing a method for manufacturing an electrode of a secondary battery according to some embodiments of the present disclosure.

Referring to FIG. 6, a method 600 for manufacturing an electrode of a secondary battery electrode may be performed by the apparatus 10 for manufacturing an electrode of a secondary battery according to some embodiments of the present disclosure.

A mixed solution containing, e.g., a positive electrode active material, a conductive agent, a binder, and an NMP solvent may be stirred (610). In an implementation, the stirring device 100 of FIG. 1 may stir the mixed solution containing the positive electrode active material, the conductive material, the binder, and the NMP solvent. The stirred mixed solution may be a positive electrode slurry.

Next, a de-ironizing process may be performed on the positive electrode slurry (620). In an implementation, the de-ironizing device 200 of FIG. 1 may perform the de-ironizing process on the positive electrode slurry. Accordingly, the iron component contained in the positive electrode slurry may be removed.

After the de-ironizing process, a degassing process may be performed on the positive electrode slurry from which the iron component has been removed (630). In an implementation, the degassing device 300 of FIG. 1 may perform the degassing process on the positive electrode slurry from which the iron component has been removed. Accordingly, air bubbles contained in the positive electrode slurry may be removed.

After the degassing process, the positive electrode slurry from which the air bubbles have been removed may be stored while being stirred for a certain period of time (640). In an implementation, the degassing device 300 may store the positive electrode slurry from which the air bubbles have been removed while stirring the positive electrode slurry for a certain period of time. Accordingly, the viscosity of the positive electrode slurry may be reduced.

Next, the positive electrode slurry with the reduced viscosity may be applied onto the positive electrode plate. In an implementation, the coating device 400 of FIG. 1 may apply the positive electrode slurry with the reduced viscosity onto the positive electrode plate.

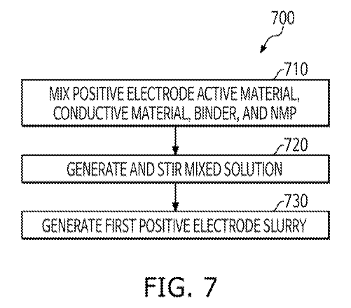

Operations of the method 600 for manufacturing an electrode of a secondary battery are described in detail with reference to FIGS. 7 to 9.

FIG. 7 illustrates a flowchart of an operation 700 of generating a first positive electrode slurry. In an implementation, the stirring device 100 may perform the operation 700 of generating the first positive electrode slurry.

Referring to FIG. 7, a positive electrode active material, a conductive material, a binder, and an NMP solvent may be mixed (710). In some embodiments, the positive electrode active material, the conductive agent, the binder, and the additive may be mixed with the NMP solvent.

Next, a mixed solution containing the positive electrode active material, the conductive agent, the binder, and the NMP solvent or a mixed solution containing the positive electrode active material, the conductive agent, the binder, the additive, and the NMP solvent may be generated, and the mixed solution may be stirred (720). While the mixed solution is stirred, the first positive electrode slurry may be generated (730).

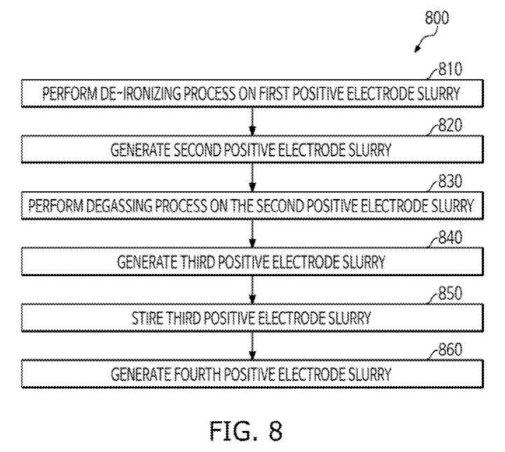

FIG. 8 illustrates a flowchart of an operation 800 of generating second to fourth positive electrode slurries. In an implementation, the de-ironizing device 200 and the degassing device 300 may perform the operation 800 of generating the second to fourth positive electrode slurries.

Referring to FIG. 8, a de-ironizing process may be performed on the first positive electrode slurry (810). As the iron component contained in the first positive electrode slurry is removed, the second positive electrode slurry 22 may be generated (820).

Next, a degassing process may be performed on the second positive electrode slurry (830). As air bubbles contained in the second positive electrode slurry are removed, the third positive electrode slurry may be generated (840).

Next, the third positive electrode slurry may be stirred for a certain period of time (850). As the third positive electrode slurry is stirred, the viscosity of the third positive electrode slurry may be reduced. As the viscosity of the third positive electrode slurry is reduced, the fourth positive electrode slurry may be generated (860).

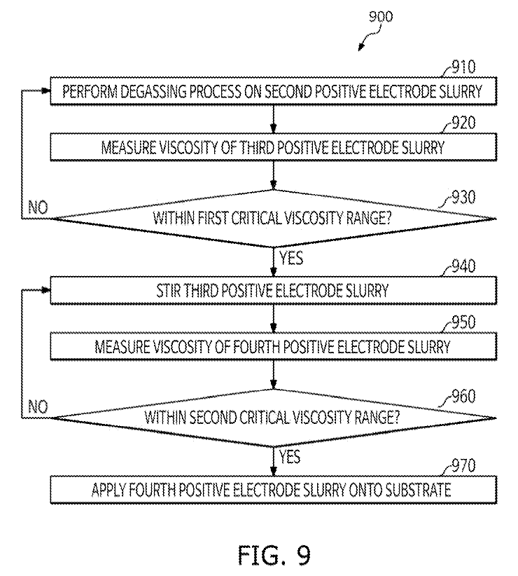

FIG. 9 illustrates a flowchart of an operation 900 of measuring the viscosity of the third positive electrode slurry and the fourth positive electrode slurry. In an implementation, the measuring device 340 of the degassing device 300 may perform the operation 900 of measuring the viscosity of the third positive electrode slurry and the fourth positive electrode slurry.

Referring to FIG. 9, a degassing process may be performed on the second positive electrode slurry (910). The third positive electrode slurry may be generated through the degassing process.

Next, the viscosity of the third positive electrode slurry may be measured (920). It may be determined whether the viscosity of the third positive electrode slurry is within a first critical range (930). The first critical range may be, e.g., 2,500 cPs to 3,500 cPs. In a case where the viscosity of the third positive electrode slurry is within the first critical range, the third positive electrode slurry may be stirred (940). In some embodiments, in a case where the viscosity of the third positive electrode slurry is higher than the first critical range, the degassing process may be performed again on the second positive electrode slurry (910).

Subsequently, as the third positive electrode slurry is stirred, the fourth positive electrode slurry may be generated. The viscosity of the fourth positive electrode slurry may be measured (950). It may be determined whether the viscosity of the third positive electrode slurry is within a second critical range (960). The second critical range may be, e.g., 1,500 cPs to 1,700 cPs. In a case where the viscosity of the fourth positive electrode slurry is within the second critical range, the fourth positive electrode slurry may be applied onto the positive electrode plate (970). In a case where the viscosity of the fourth positive electrode slurry is higher than the second critical range, the third positive electrode slurry may be stirred again for a critical period (940).

As described above, the method for manufacturing an electrode of a secondary battery according to some embodiments may improve the efficiency of the process of manufacturing an electrode of a secondary battery by controlling the positive electrode slurry to have an optimal viscosity before applying the positive electrode slurry onto the positive electrode plate.

By way of summary and review, a secondary battery may be manufactured by inserting an electrode assembly including a positive electrode plate, a negative electrode plate, and a separator into a case and then sealing the case with a cap plate. The positive electrode plate may be manufactured by applying a slurry for a positive electrode active material onto a substrate, and the negative electrode plate may be manufactured by applying a slurry for a negative electrode active material onto a substrate. The viscosity of the slurry for the positive electrode active material may vary depending on the manufacturing process. In a case where the viscosity of the slurry for the positive electrode active material is high, there may be a problem in that the slurry for the positive electrode active material may be non-uniformly applied onto the substrate. Accordingly, an efficient method capable of controlling a slurry to have an optimal viscosity is required.

Aspects of embodiments of the present disclosure provide an apparatus and method for manufacturing an electrode of a secondary battery.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

What is claimed is:

1. An apparatus for manufacturing an electrode of a secondary battery, the apparatus comprising:
a stirring device to generate a first positive electrode slurry, the stirring device configured to sir a mixed solution containing a positive electrode active material, a conductive agent, a binder, and an N-methyl-n-pyrrolidone (NMP) solvent;
a de-ironizing device to generate a second positive electrode slurry, the de-ironizing device configured to perform a de-ironizing process on the first positive electrode slurry from the stirring device;
a degassing device for generating a third positive electrode slurry, the degassing device configured to perform a degassing process on the second positive electrode slurry from the de-ironizing device and to stir the second positive electrode slurry; and
a coating device to apply the third positive electrode slurry from the degassing device onto a positive electrode plate.

2. The apparatus as claimed in claim 1, wherein the degassing device includes a measuring device configured to measure a viscosity of the third positive electrode slurry.

3. The apparatus as claimed in claim 1, wherein the de-ironizing device includes:
a first storage tank configured to store the first positive electrode slurry transferred from the stirring device; and
a de-ironizer configured to remove an iron component from the first positive electrode slurry.

4. The apparatus as claimed in claim 3, wherein the de-ironizer is configured to perform the de-ironizing process for 80 minutes to 100 minutes.

5. The apparatus as claimed in claim 1, wherein the degassing device includes:
a second storage tank configured to store the second positive electrode slurry transferred from the de-ironizing device;
a vacuum degasser configured to remove air bubbles from the second positive electrode slurry in a vacuum; and
a stirrer configured to stir the second positive electrode slurry from which the air bubbles have been removed.

6. The apparatus as claimed in claim 5, wherein the vacuum degasser is configured to perform the degassing process for 80 minutes to 100 minutes.

7. The apparatus as claimed in claim 5, wherein the stirrer is configured to stir the second positive electrode slurry from which the air bubbles have been removed for 25 days to 30 days.

8. The apparatus as claimed in claim 7, wherein the stirrer includes a rotary blade configured to rotate at a stirring rotation speed of 15 rpm to 25 rpm.

9. The apparatus as claimed in claim 7, wherein the stirrer is configured to stir the second positive electrode slurry from which the air bubbles have been removed at a temperature of 20°C to 30°C.

10. The apparatus as claimed in claim 1, wherein the degassing device
is configured to generate a third positive electrode slurry having:
a solid concentration of 70 wt% to 80 wt%, and
a viscosity of 500 cPs to 1,700 cPs.

11. An apparatus for manufacturing an electrode of a secondary battery, the apparatus comprising:
a stirring device configured to generate a first positive electrode slurry by stirring a mixed solution containing a positive electrode active material, a conductive agent, a binder, and an N-methyl-n-pyrrolidone (NMP) solvent;
a de-ironizing device configured to generate a second positive electrode slurry by performing a de-ironizing process on the first positive electrode slurry transferred from the stirring device;
a degassing device configured to generate a third positive electrode slurry by performing a degassing process on the second positive electrode slurry transferred from the de-ironizing device and to generate a fourth positive electrode slurry by stirring the third positive electrode slurry; and
a coating device configured to apply the fourth positive electrode slurry transferred from the degassing device onto a positive electrode plate.

12. The apparatus as claimed in claim 11, wherein:
the de-ironizing device includes a first storage tank configured to store the first positive electrode slurry transferred from the stirring device,
the degassing device includes:
a second storage tank configured to store the second positive electrode slurry transferred from the de-ironizing device;
a vacuum degasser configured to remove air bubbles from the second positive electrode slurry in a vacuum;
a third storage tank configured to store the third positive electrode slurry transferred from the second storage tank; and
a stirrer configured to stir the third positive electrode slurry.

13. The apparatus as claimed in claim 12, wherein the degassing device further includes a measuring device configured to measure a viscosity of the third positive electrode slurry and the fourth positive electrode slurry.

14. The apparatus as claimed in claim 12, wherein the degassing device
is configured to generate a third positive electrode slurry having:
a solid concentration of 70 wt% to 80 wt%, and
a viscosity of 2,500 cPs to 3,500 cPs.

15. The apparatus as claimed in claim 12, wherein the degassing device
is configured to generate a fourth positive electrode slurry having:
a solid concentration of 70 wt% to 80 wt%, and
a viscosity of 1,500 cPs to 1,700 cPs.

16. A method for manufacturing an electrode of a secondary battery, the method comprising:
generating a first positive electrode slurry by stirring a mixed solution containing a positive electrode active material, a conductive agent, a binder, and an N-methyl-n-pyrrolidone (NMP) solvent;
generating a second positive electrode slurry by performing a de-ironizing process on the first positive electrode slurry;
generating a third positive electrode slurry by performing a degassing process on the second positive electrode slurry;
generating a fourth positive electrode slurry by stirring the third positive electrode slurry for a certain period of time; and
applying the fourth positive electrode slurry onto a positive electrode plate.

17. The method as claimed in claim 16, further including measuring a viscosity of the third positive electrode slurry and the fourth positive electrode slurry.

18. The method as claimed in claim 16, wherein the generating the second positive electrode slurry includes performing the de-ironizing process for 80 minutes to 100 minutes.

19. The method as claimed in claim 16, wherein the generating the third positive electrode slurry includes performing the degassing process for 80 minutes to 100 minutes.

20. The method as claimed in claim 16, wherein the generating the fourth positive electrode slurry includes stirring the third positive electrode slurry at a temperature of 20°C to 30°C for 25 days to 30 days.
